(19) United States
(12) Patent Application Publication
(10) Pub. No.: US 2025/0344650 A1
(43) Pub. Date: Nov. 13, 2025

(54) METHOD OF MODIFYING WEATHER WITH ALTITUDE TARGETING DROP BAGS WITH BIODEGRADABLE PALLETS

(71) Applicant: Jerome Eisenberg, Boca Raton, FL (US)

(72) Inventors: Peter Cordani, Jupiter, FL (US); Jerome Eisenberg, Boca Raton, FL (US)

(21) Appl. No.: 19/274,219

(22) Filed: Jul. 18, 2025

Related U.S. Application Data
(63) Continuation-in-part of application No. 17/354,014, filed on Jun. 22, 2021, now Pat. No. 12,364,212.
(60) Provisional application No. 63/047,441, filed on Jul. 2, 2020.

(51) Int. Cl. A01G 15/00

(52) U.S. Cl. CPC A01G 15/00

(57) ABSTRACT

A method of modifying weather by placing a superabsorbent polymer at various altitudes in a storm cloud. The superabsorbent polymer placed with biodegradable bags for target positioning on biodegradable pallets for deployment. The polymer dispensed in sufficient quantities to create a gel-like substance that precipitates causing an internal constriction within the cloud to lessen storm velocities. The pallets provide a controlled descent during deployment.

### PRIORITY CLAIM

In accordance with 7 C.F.R. § 1.76, a claim of priority is included in an Application Data Sheet filed concurrently herewith. Accordingly, the present invention claims priority as a continuation-in-part of U.S. patent application Ser. No. 17/354,014 entitled “METHOD OF MODIFYING WEATHER WITH ALTITUDE TARGETING DROP BAGS”, filed Jun. 22, 2021, which further claims priority to U.S. Provisional Patent Application No. 63/047,441 entitled “METHOD OF MODIFYING WEATHER WITH ALTITUDE TARGETING DROP BAGS”, filed Jul. 2, 2020. The contents of which the above referenced application is incorporated herein by reference.

### FIELD OF THE INVENTION

This invention relates generally to weather modification; and in particular, to the use of aqueous absorbing polymers dispensed at predetermined altitudes using biodegradable bags and pallets.

### BACKGROUND OF THE INVENTION

It is well known that hurricanes, tropical storms, typhoons, and the like weather patterns can cause severe damage to land, buildings, and living creatures. The resulting damage from even an isolated event can be billions of dollars. For instance, Hurricane Andrew cost $27 billion in damages, which in 1992 was considered one of the costliest storms to strike the United States. Since then, Hurricane Katrina in 2005 caused $125 billion in damages; Hurricane Wilma in 2005 caused $27 billion in damages; Hurricane Ike in 2008 caused $38 billion in damages; Hurricane Sandy in 2012 caused $68 billion in damages; Hurricane Irma in 2017 caused $77 billion in damages; Hurricane Maria in 2017 caused $90 billion in damages; and Hurricane Harvey in 2017 caused $125 billion in damages.

U.S. Pat. No. 6,315,213 discloses a method for artificially modifying the weather by seeding rain clouds of a storm with suitable cross-linked aqueous polymer. The polymer is dispersed into the cloud and the wind of the storm agitates the mixture, causing the polymer to absorb the rain. This reaction forms a gelatinous substance which precipitates to the surface below.

U.S. Pat. No. 10,314,249 discloses a system for use in inducing rainfall. The system includes an aircraft configured to travel through an ambient environment at a first temperature, and a precipitation system coupled to the aircraft. The precipitation system is configured to form a particle from a substance in the ambient environment and is configured to discharge the particle at a second temperature which is lower than the first temperature, such that moisture in the air condenses on the particle.

U.S. Patent Publication No. 2013/0206912 discloses a method of reducing the amount of water in a region of air including: forming seed ice crystals; dispensing the seed ice crystals towards the region of air; allowing water in the region of air to freeze or deposit onto the seed ice crystals; and allowing the resulting ice crystals to move from the region of air so as to reduce the amount of water in the region of air. An ice crystal seeding assembly is arranged to reduce the amount of water in a region of air. The seeding assembly includes an ice crystal seeder and dispensing means; the dispensing means being arranged to dispense seeded ice crystals towards the region of air so that water in the region of air freezes or deposits onto the seed ice crystals and the resulting ice crystals move from the region of air.

U.S. Pat. No. 5,174,498 discloses a cloud seeding material useful for seeding supercooled clouds in order to augment rainfall. The material used in seeding is defined as an aliphatic long-chain alcohol.

U.S. Pat. No. 4,600,147 discloses a cloud seeding method of inserting liquid propane from a rocket. The liquid propane is used to generate large numbers of ice crystals in supercooled clouds.

U.S. Pat. No. 5,357,865 discloses yet another method of cloud seeding. This invention includes the use of a pyrotechnic composition, such as potassium chlorate or potassium perchlorate, which acts as nuclei for precipitable water drop formation.

U.S. Pat. No. 4,096,005 discloses a pyrotechnic cloud seeding composition comprising silver iodate and a fuel consisting of aluminum and magnesium.

A problem with known seeding is that the interaction of the material and water occurs the moment the material contacts moisture in the atmosphere. For proper dispersement of the seeding materials, the materials need to be positioned at various altitudes. Unfortunately, that requires the use of rockets or airplanes to be placed at predetermined altitudes. The use of a rocket for delivery can result in damage should the empty shell return to earth improperly. Dispersement of material by an airplane would require the plane to fly at different altitudes, exposing the aircraft and crew to unpredictable conditions. On the average, the temperature drop for every 1,000 feet of altitude is 3.5 degrees Fahrenheit. If the cloud seeding is only performed along the tops of the clouds, the material will be immediately activated upon encountering moisture.

The prior art teachings are directed to methods of creating rain. What is lacking in the art is a method of lessening wind velocities of a storm by placement of material at predetermined altitudes held by biodegradable bags and pallets.

### SUMMARY OF THE INVENTION

The instant application discloses a method of modifying weather by seeding storm clouds at various altitudes with a polymer using biodegradable bags and pallets. A superabsorbent polymer is placed into the storm cloud at particular altitudes to cause a large absorption of water. The reaction of the water with the polymer creates a gel-like substance that precipitates to the surface, thus causing an internal constriction within the cloud to lessen storm velocities.

Accordingly, it is an objective of the instant invention to present a method for artificially modifying weather wherein a polymer is placed at different altitudes to allow wind dissipation by weighting condensation with the clouds using biodegradable bags and pallets.

It is another objective of the instant invention to present a method for seeding a rain cloud with cross-linked polymer packages in various wrappings, each designed to disintegrate, thereby releasing the polymer at predetermined temperatures, whereby the wind of the storm provides the agitation for the reaction of the polymer with the water.

Another objective of the invention is to teach the use of packaged polymers that can be distributed at a safe altitude for the protection of the aircraft and aircraft crew using pallets that degrade into consumable fish food.

It is an additional objective of the instant invention to present a method for modifying storms such that the end product is biodegradable and nonhazardous.

Other objectives and advantages of this invention will become apparent from the following description wherein are set forth, by way of example, certain embodiments of this invention.

### BRIEF DESCRIPTION OF THE FIGURES

FIG. 1 is a perspective view of a biodegradable pallet;

FIG. 2 is a perspective view of a dispensing bag strapped to the pallet;

FIG. 3A is a pictorial view of bag strapped to a pallet immediately after being displaced from an aircraft; and

FIG. 3B is a pictorial view of the pallet operating as a wind drogue to the dispensing bag.

### DETAILED DESCRIPTION OF THE INVENTION

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Referring to the drawings, disclosed is method for artificially modifying weather by solidifying portions of a cloud in a storm by introducing “superabsorbent” aqueous based polymers, preferably cross-linked modified polyacrylamides, into a cloud at predetermined altitudes using a biodegradable, ocean-safe pallet 10 constructed from fish consumable ingredients, egg whites, corn starch, and molasses that is compressed in a molding machine in a shape to hold a bag of the superabsorbent polymers until deployment from an aircraft. The pallet 10 being strong enough to carry a prescribed load for storage and during transport, and remain water-soluble and environmentally safe after use. The pallet 10 is defined as a first edge 12, second edge 14 and opposing side edges 16 and 18. An upper surface 20 having a series of air channeling slots 22, and edge receptacles 24 that provide legs 26 in a sufficient height to allow forklift openings 30.

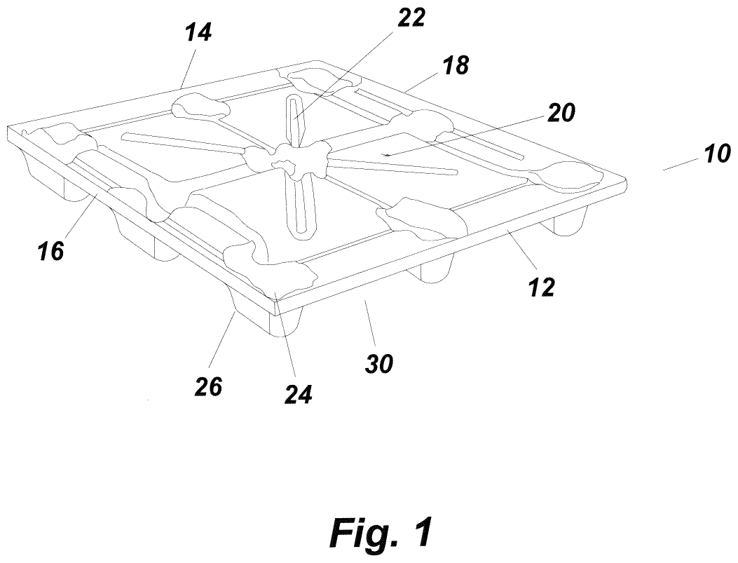

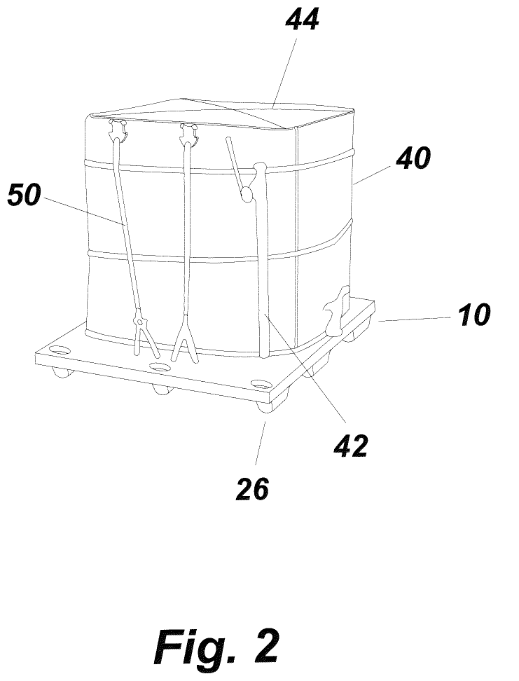

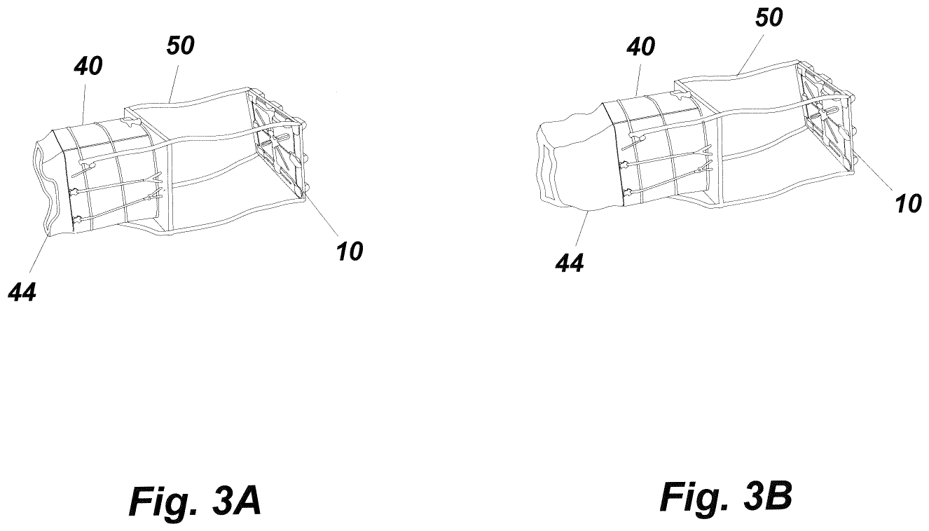

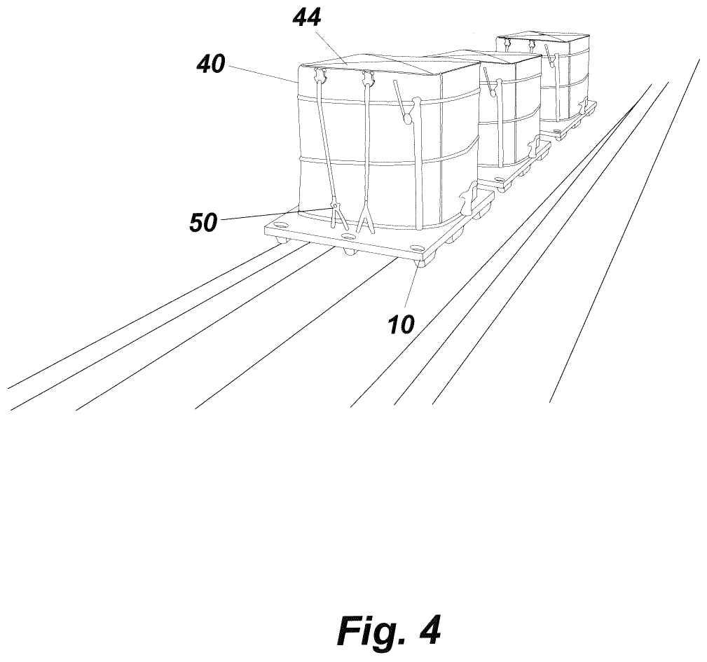

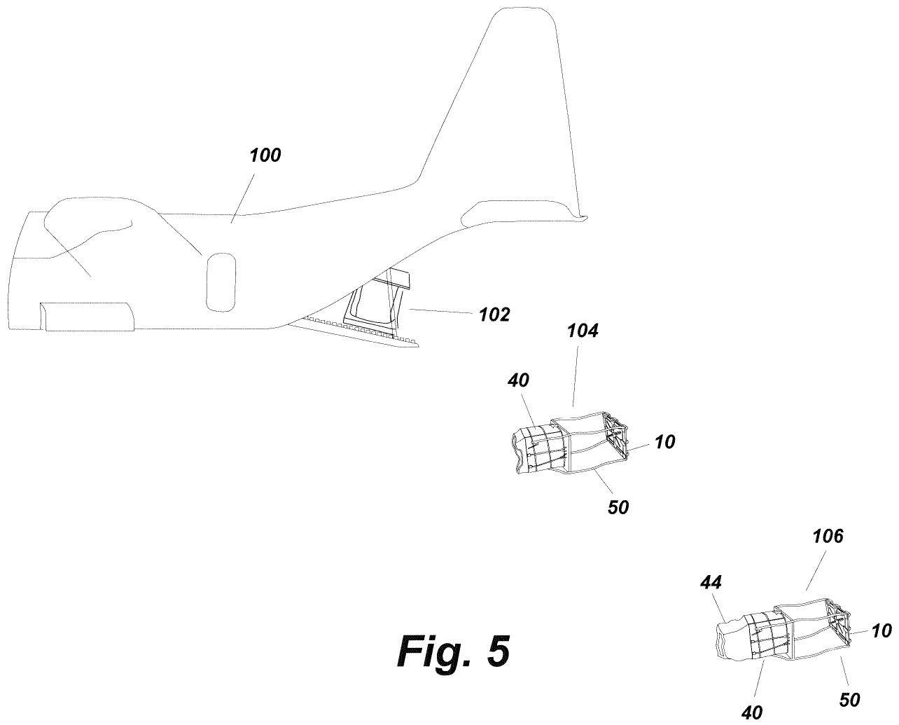

In a preferred embodiment the pallet 10 is formed from fish food bulk which are nutrients for fish and provide structural filler. Egg whites provide a natural binder and protein-based “glue” (albumin). Corn starch operates as a thermoplastic filler and a hardener when heated. Molasses operates as a plasticizer, binder, and adds nutrients and flexibility. The method of making the biodegradable, ocean safe pallet is by grinding the fish food into a coarse flour for uniform mixing. Using powdered egg whites, reconstitute with water at 1:7 ratio (powder:water); warm the molasses to make it easier to mix with a target moisture of about 20%. During mixing, the fish food is combined with the corn starch to make admixture while adding egg whites to create a paste. With a paste like admixture, molasses is added to form a dough-like consistency. The admixture is place in a pallet mold to form a mold shaped as depicted in FIG. 1. Small amounts of water can be added if needed. Placed in a mold, the admixture is pressed with a hydraulic press to remove air pockets. In a preferred embodiment, a heated press (˜80-100° C./175-212° F.) is used to apply pressure for 15-30 minutes to harden the form by reducing moisture. The target moisture is less than 10 percent. Alternatively, the pallet can be air dried for at least 3 days or oven dried at 65-75° C. (150-170° F.) for at least 6 hours. Depending on the predicted storage time or requirement for fast dissolving, the corn starch can be adjusted down and the molasses increased to speed up dissolving (more water solubility) or increase the egg whites/starch to delay dissolving when longer storage periods are predicted.

In the preferred embodiment, a vegetable based fish food such as spirulina pellets, algae wafers, or herbivore fish diets produces very low odor and provide a digestible plant matter. Alternatively, aquaculture feed formulation using tilapia, goldfish or koi have a low odor versus high protein fish foods.

The pallet 10 supports a quantity of superabsorbent polymer place in a bag 40 formed of a water soluble film constructed from a copolymer polyvinyl alcohol (PVA) resin. The PVA resin is between 30 and 90 microns with a preferred embodiment of 40 microns. One grade of PVA resin can dissolve when exposed to 50° F. water in about 38-55 seconds and 68° F. water in about 29-40 seconds. A second grade of PVA resin can dissolve when exposed to 50° F. water in about 35-47 seconds and 68° F. water in about 25-35 seconds. A third grade of PVA resin can dissolve when exposed to 50° F. water in about 23-33 seconds and 68° F. water in about 19-26 seconds.

The PVA is formed into bags that hold the polymer in a dry state. An airplane used to dispense the bags can then fly at a first height while the bag allows dispersement of the material at a second height. The PVA can be chosen from a cold or warm water soluble grade. For assembly, the bag can be formed entirely from PVA and the material is heat sealable with a standard hot bar, impulse, or water and sonic sealing methods. PVA film barrier provides protection for the polymer, is solvent resistant, and oils will not migrate through the film. The PVA film also provides a barrier to carbon dioxide, hydrogen, and oxygen.

The cargo of the bag are superabsorbent polymers prepared from water-soluble polymers, but have cross-linking structures which render the polymers water-insoluble. By taking water-soluble ethylenically unsaturated monomers which readily undergo vinyl polymerization, such as acrylamide, with the use of cross-linking agents, a polymer can be produced that is of uniform small size, has a high gel capacity, is highly insoluble, but highly water swellable, i.e. a superabsorbent polymer. Superabsorbent polymers can be dehydrated to a powder. When the powder is added to an aqueous solution and agitated, the polymer is able to absorb many times its weight of the water molecules, and a gel-like substance is formed. Superabsorbent polymers are particularly suited for uses where rapid absorption of aqueous fluid is desired or for uses where the swelling properties in water are employed.

In the present invention, a solid form of the superabsorbent polymer, such as a powder, is introduced into the rain clouds of a storm at predetermined altitudes. While the polymer is light in weight while dry, the amount of polymer required necessitates a bag of sufficient size which can be easily transported on a pallet. The amount of polymer needed is predetermined based upon the size and severity of the storm along with the absorption capacity of the polymer used. In the preferred embodiment, the method for artificially modifying weather by seeding a rain cloud comprises: forming an aqueous solidifier material capable of retaining over three hundred times its own weight in water, wherein said aqueous solidifier material is a cross-linked aqueous based polymer; storing a volume of said aqueous solidifier material in a water soluble film forming a drop bag; expelling said drop bag from an airplane at a first altitude; and dispersing said material into a suitable cloud formation upon breaching said drop bag at a second altitude, wherein the wind generated by the storm causes said solidifier to mix with rain to form a gel like substance; said gel like substance being of sufficient weight to precipitate to the surface below, thereby diminishing the velocity of the cloud. The kind of storm clouds that form a hurricane are cumulonimbus clouds, particularly those that organize into large, rotating systems. Cumulonimbus clouds contain both liquid water and ice, depending on the altitude within the cloud.

The bags 40 are attached to the pallet by straps 50 constructed of biodegradable materials. Preferably the straps 50 are constructed from jute or hemp plant fibers. When the straps are configured in a webbing, they provide short term strength for securing the bag to pallet during a bag drop. In a preferred embodiment, four straps are employed securing the bag to the pallet during storage and transport. One strap is preferably attached to each side edge of the pallet and coupled to the bag. Each strap has an attachment length for use when the bag is attached to the pallet, and a deployment length for when the bag and pallet are deployed from an airplane wherein the pallet becomes detached from the pallet position wherein the pallet operates as a wind drogue to control the free fall of the bag. For short term pallet handling, the bag 40 can be bound to the pallet 10 by a removable binder 42. The binder 42 assures stable transport of the bag 40 during takeoff and airplane maneuvering. The binder 42 is removed prior to bag deployment.

When a pallet 10 composed of biodegradable materials is strapped to a polymer deployment bag 40 and dropped from an airplane, it can function effectively as a drogue by utilizing aerodynamic drag to stabilize and slow the descent of the bag. The pallet's flat, broad structure increases air resistance, while the polymer bag-designed to unfurl the top 44 during freefall-acts as a drag surface that orients and steadies the load beneath the aircraft. As the assembly descends, the airflow engages the extended bag 40 and pallet 10 surface area, producing sufficient drag to control the fall trajectory and velocity. This configuration is particularly useful to provide a controlled descent and stable deployment for accurate placement of the bags in the storm cloud.

Referring to FIG. 5 once the bag 102 is dropped from an airplane 100, the PVA will disintegrate at a predetermined altitude, wind provides the agitation that causes the polymer to bind with the moisture in the storm cloud forming a gel-like substance. As depicted by element 104, the straps 50 being to unfold between the pallet 10 and the bag 40. As depicted by element 106, the straps 50 are fully extended from the bag 40 wherein the pallet 10 provides an aerodynamic drag to assure the polymer is dispensed from a controlled deployment. As a result of this method, wind based water storms can be artificially modified. The use of a biodegradable polymer allows for safe use of the ocean, wherein the high salinity of the water will expedite the degradation of the material. Various biodegradable super-absorbent polymers include carboxy-methylcellulose, alginic acid, cross-linked starches, cross-linked polyamino, acids and cross-linked modified polyacrylamides.

In a dry state, the preferred polymer may be considered a particle having a diameter less than 4000 microns but greater than 50 microns. In a swollen state, the particle may have a diameter greater than three hundred times its weight. In a totally water-swollen state, the particles contain up to about 99.98 weight percent of water and as little as about 0.1 weight percent of polymer. Thus, such particles could hold from ten to thousands of times their own weight. By seeding a leading edge of a violent storm, such as a hurricane, the winds cause a mix of the material wherein moisture is absorbed by the material, causing a shearing effect. The shearing effect causes the polymers to absorb, lose, and reabsorb water countless times. During this exchange, the weight of the water being transferred allows for wind shearing that assists in lessening the velocity of the wind.

The shearing forces are affected by the nature of the interactions between the particles during such collisions. When attractive forces dominate, the particles will aggregate and the dispersion may destabilize.

Example: A hurricane is seeded with approximately 30,000 lbs. of a superabsorbent aqueous based polymer by use of a transport plane flying through the leading edge of the storm. Within twenty seconds, the polymer will obtain over 70 percent of its absorption capacity or nearly three hundred times its weight. The winds of the storm will continue to disperse the materials, causing a form of internal flocculation, disrupting the feeding nature of the storm. When presented close to land, the storm will not have sufficient time to reform to its previous strength.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features.

What is claimed is:

1. A method for artificially modifying weather by seeding a rain cloud, comprising:
selecting an aqueous solidifier material capable of retaining over three hundred times its own weight in water, wherein said aqueous solidifier material is a cross-linked aqueous-based polymer;
storing a quantity of said aqueous solidifier material in biodegradable drop bags formed from a water soluble film;
constructing biodegradable pallets from an admixture of fish food, powdered egg whites, corn starch and molasses;
attaching a plurality of straps constructed from natural plant fibers to said pallet and said bag, each strap having an attachment length and a deployment length;
placing said drop bags having aqueous solidifier material on said pallets;
dispensing said pallets and drop bags from an airplane at a first altitude into a storm cloud formation;
breaching said drop bags at one or more predetermined altitudes lower than said first altitude wherein said aqueous solidifier material is released and mixes with rain cloud moisture to form a gel-like substance capable of diminishing the velocity of the storm cloud, wherein said straps extend to their deployment lengths detaching the pallet from the bag, said pallet functioning as a wind drogue creating aerodynamic drag to stabilize the descent trajectory and velocity of the bag during free fall.

2. The method of claim 1 wherein said step of constructing is further defined as:
grinding said fish food into a coarse material, said fish food containing nutrients for aquatic life and acting as a structural filler;
reconstituting said powdered egg whites with water at a ratio of approximately 1:7 (powder:water) to form a protein-based binder comprising albumin;
adding corn starch to act as a thermoplastic filler to form an admixture;
mixing warm molasses to said admixture to reduce viscosity and facilitate mixing, wherein molasses functions as a binder, and nutrient additive in an amount to form a dough-like consistency with a target moisture content of approximately 20%; solidifying said admixture in a pallet mold.

3. The method of claim 1 including the steps of: pressing the admixture in a mold using a hydraulic press to remove air pockets;
applying heat at a temperature of approximately 80° C. to 100° C. for about 15 to 30 minutes to reduce the moisture content to less than 10%, thereby hardening the pallet.

4. The method of claim 2 including the steps of: pressing the admixture in the mold using a hydraulic press to remove air pockets;
air drying said admixture in the mold for at least 3 days or oven drying at a temperature of approximately 65° C. to 75° C. for at least 6 hours.

5. The method of claim 1 wherein said water soluble film is a copolymer PVA resin between 30 and 90 microns.

6. The method of claim 4 wherein said PVA resin dissolves when exposed to water in about 29 seconds allowing release at a predetermined height above the ground.

7. The method of claim 4 wherein said PVA resin dissolves when exposed to water in about 25 seconds allowing release at a predetermined height above the ground.

8. The method of claim 4 wherein said micron PVA resin dissolves when exposed to water in about 19 seconds allowing release at a predetermined height above the ground.

9. The cross-linked aqueous polymer of claim 1 wherein said polymer is a cross-linked modified polyacrylamide.

10. The cross-linked polymer of claim 1 wherein said material is between 50 and 4000 microns.

11. The method of claim 1 wherein the amount of said aqueous solidifier material needed is precalculated based upon the size of the storm and the absorption properties of said aqueous solidifier material.

12. The method of claim 1 wherein said straps are selected from the group consisting of jute or hemp.
